(19) United States
(12) Patent Application Publication
(10) Pub. No.: US 2003/0070899 A1
(43) Pub. Date: Apr. 17, 2003

(54) Multiple disk clutch

(76) Inventor: Klaus Herberg, Brackenheim (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/242,719

(22) Filed: Sep. 13, 2002

(30) Foreign Application Priority Data
Sep. 15, 2001 (DE) 101 45 638.7

(51) Int. Cl. F16D 13/52; F16D 69/00

(52) U.S. Cl. 192/107 M; 192/70.2

(57) ABSTRACT

A clutch of a friction type between an internal-combustion engine and a transmission is installed in a motor vehicle, for example, of the high-performance class, and comprises drive friction disks and transmission friction disks. For increasing the stressing capacity of the drive friction disks and of the transmission friction disks, at least the drive friction disks consist of a material of a high resistance to wear and a high rotational speed stability.

This application claims the priority of German Patent Application No. 101 45 638.7, filed Sep. 15, 2001, the disclosure of which is expressly incorporated by reference herein.

### BACKGROUND OF THE INVENTION

The present invention relates to a clutch, preferably a multi-disk clutch of the friction type, between an internal-combustion engine and a transmission of a high-performance motor vehicle, comprising drive friction disks and transmission friction disks.

A known multi-disk clutch, as seen in DE 33 26 409 A1, comprises several friction disks which are arranged side-by-side and are provided on only one side with a friction layer.

Clutch disks are also known from U.S. Pat. No. 5,029,686 between which separating disks made of steel are provided. The separating disks are provided with a layer made of a ceramic material.

U.S. Pat. No. 5,452,784 describes a multi-disk clutch whose drive friction disks and transmission friction disks have a thin film made of ceramics on the mutually facing surfaces.

In the case of automatically operating starting clutches in high-performance vehicles, which participate, for example, in Formula 1 competitions, the drive friction disks and the transmission friction disks are highly stressed with respect to wear and rotational speed, which impairs the service life of these disks consisting of carbon.

### SUMMARY OF THE INVENTION

An object of the present invention is, therefore, to clearly increase the stressing capacity of the drive friction disks and of the transmission friction disks.

According to the invention, this object has been achieved by providing that at least the drive friction disks consist of a material of a high resistance to wear and a high rotational speed stability.

Principal advantages achieved with the invention are that the drive friction disks and the transmission friction disks, because they consist of a suitable material, very well withstand the high stress (rotational speed and wear) which occurs particularly during the operation of automatic starting clutches. Mainly a fabric-reinforced ceramic material is a very suitable material for the drive friction disks and the transmission friction disks. It was found to be advantageous for each individual disk, as a whole, to be made of fabric-reinforced ceramic material, specifically without any cover layer in the area of the friction surfaces.

### BRIEF DESCRIPTION OF THE DRAWINGS

These and other objects, features and advantages of the present invention will become more readily apparent from the following detailed description of currently preferred configurations thereof when taken in conjunction with the accompanying drawings wherein:

FIG. 1 is a longitudinal sectional view of a clutch arranged between an internal-combustion engine and a manual transmission according to the present invention; and

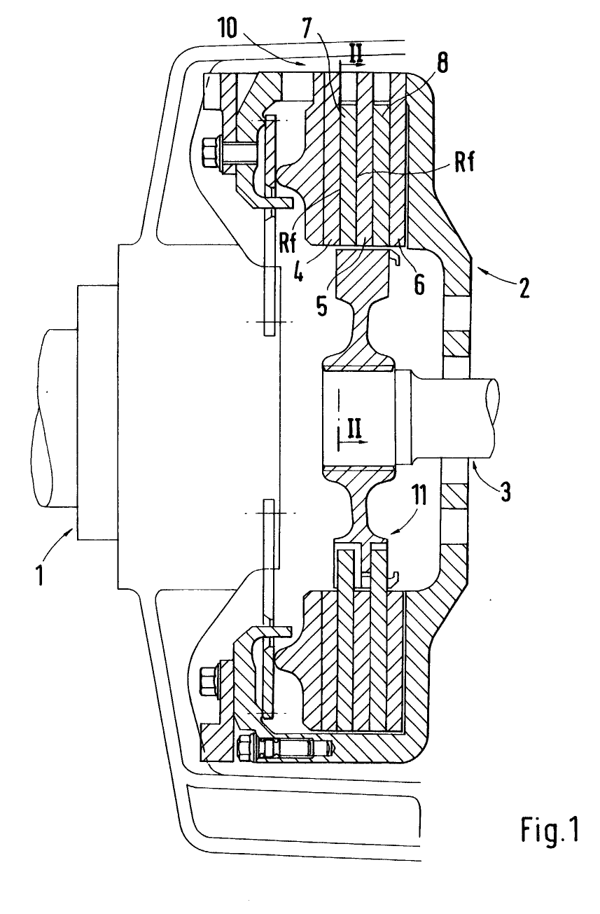

FIG. 2 is a sectional view along line II-II of FIG. 1.

### DETAILED DESCRIPTION OF THE DRAWINGS

Of an internal-combustion engine installed in a motor vehicle, only a crankshaft 1 which interacts with a transmission by way of a friction-type clutch 2 need be illustrated for a full understanding of the present invention. The transmission is connected with the clutch 2 by an input shaft 3 in a generally known manner.

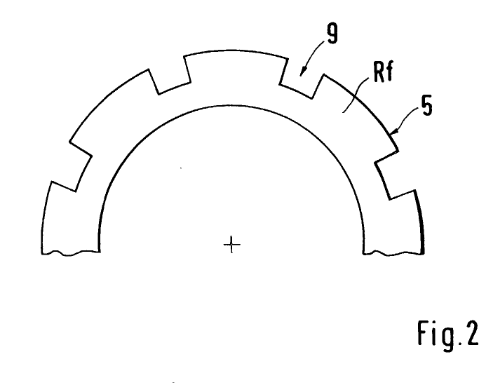

The clutch 2 is constructed as a multi-disk clutch and has drive friction disks 4, 5, 6 as well as transmission friction disks 7, 8. Each drive friction disk, for example, 5, is formed by a rotationally symmetrical element, has driving pockets 9 (As seen in FIG. 2) and is axially displaceably disposed in a clutch housing 10. The individual drive friction disks 7, 8 have a similar construction but are axially movably arranged by generally known driving pins on a clutch hub 11.

The drive friction disks 4, 5, 6 as well as the transmission friction disks 7, 8 are produced of a material of a high resistance to wear and a high rotational-speed stability. The disks have no cover layer on the friction surfaces Rf. In this case, the drive friction disks 4, 5, 6 as well as the transmission friction disks 7, 8 can consist of the same material. Tests have demonstrated that a fabric-reinforced ceramic material is excellently suitable for the drive friction disks 4, 5, 6 and the transmission friction disks 7, 8.

Drive friction disks 4, 5, 6 and transmission friction disks 7, 8 made in this manner can be used in a targeted fashion in automatic starting clutches of motor vehicles whose internal-combustion engines deliver maximum values with respect to rotational speeds and power, whereby the above-mentioned drive disks and transmission disks are extremely stressed.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. Clutch, particularly a multi-disk friction-type clutch, between an internal-combustion engine and a transmission, of a high-performance motor vehicle, comprising drive friction disks and transmission friction disks, wherein at least the drive friction disks consist of a material of a high resistance to wear and a high rotational speed stability.

2. Clutch according to claim 1, wherein the drive friction disks and the transmission friction disks consist of a material of a high resistance to wear and a high rotational speed stability.

3. Clutch according to claim 1, wherein at least the drive friction disks consist of a fabric-reinforced ceramic material.

4. Clutch according to claim 3, wherein the drive friction disks and the transmission friction disks consist of a material of a high resistance to wear and a high rotational speed stability.

5. Clutch according to claim 1, wherein the drive friction disks and the transmission friction disks consist of a fabric-reinforced ceramic material.

6. Clutch according to claim 1, wherein the drive friction disks and the transmission friction disks are produced of the same material.

7. Clutch according claim 1, wherein friction surfaces of the drive friction disks and of the transmission friction disks are free of cover layers.

8. Clutch according to claim 7, wherein the drive friction disks and the transmission friction disks consist of a material of a high resistance to wear and a high rotational speed stability.

9. Clutch according to claim 8, wherein at least the drive friction disks consist of a fabric-reinforced ceramic material.

10. Clutch according to claim 9, wherein the drive friction disks and the transmission friction disks consist of a fabric-reinforced ceramic material.

11. Clutch according to claim 7, wherein the drive friction disks and the transmission friction disks are produced of the same material.
